(19) United States
(12) Patent Application Publication
(10) Pub. No.: US 2013/0055763 A1
(43) Pub. Date: Mar. 7, 2013

(54) Hearts & Arrows SiC Gemstone

(71) Applicant: Anthonv Ritchie, (US)

(72) Inventor: Anthonv Ritchie, (US)

(21) Appl. No.: 13/224,468

(22) Filed: Sep. 2, 2011

(51) Int. Cl. A44C 17/00; B24B 1/00; B28D 5/00

(52) U.S. Cl. 63/32; 125/30.01; 451/41

(57) ABSTRACT

The instant application discloses, among other things, a specific set of cutting proportions tailored for the optical characteristics of Silicon Carbide (“SiC”) which may produce a “Hearts & Arrows” reflection pattern.

### FIELD

This disclosure relates to a way to produce a “Hearts & Arrows” reflection pattern in a transparent Silicon Carbide (“SiC”) gemstone.

### BACKGROUND

Generally, facets on precious and semi-precious gemstones are cut so as to provide brilliance to these gemstones in an economical manner. Gemstones may also be cut to provide reflections with patterns visible.

### SUMMARY OF THE INVENTION

The instant application discloses, among other things, a specific set of cutting proportions tailored for the optical characteristics of Silicon Carbide (“SiC”) which may produce a “Hearts & Arrows” reflection pattern.

### BRIEF DESCRIPTION OF THE DRAWINGS

FIG. 1 is a side view of an example of an SiC gemstone cut with a Hearts & Arrows pattern.

FIG. 2 is a top view of an example of an SiC gemstone cut with a Hearts & Arrows pattern.

FIG. 3 is a bottom view of an example of an SiC gemstone cut with a Hearts & Arrows pattern.

FIG. 4 is an illustration of a flowchart of one way to create an SiC gemstone with a Hearts & Arrows pattern.

FIG. 5 is an illustration of a bottom view an SiC gemstone with a Hearts & Arrows pattern.

FIG. 6 is an illustration of a top view an SiC gemstone with a Hearts & Arrows pattern.

### DESCRIPTION OF THE INVENTION

Silicon Carbide (SiC) is a compound of silicon and carbon. It exists in a number of crystalline forms, often grouped as polytypes of similar structures. Three common polytypes are 3C (β), 4H, and 6H (α). 3C (β) has a cubic crystal structure; 4H and 6H (a) each have hexagonal crystal structures.

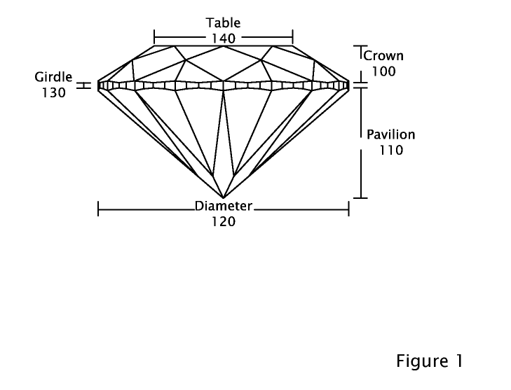

FIG. 1 is a side view of an example of an SiC gemstone cut with a Hearts & Arrows pattern. Crown 100 is the portion of a gem above the girdle. Crown 100 has star facets 200, crown main facets 210, and crown girdle facets 220. Girdle 130 is the outer edge of the gemstone, separating the Crown 100 and the Pavilion 110. Girdle 130 is generally located near the area of a gemstone at the widest portion of the gemstone, where Diameter 120 indicates the edge-to-edge width of the gemstone. Table 140 is the largest facet on the gemstone.

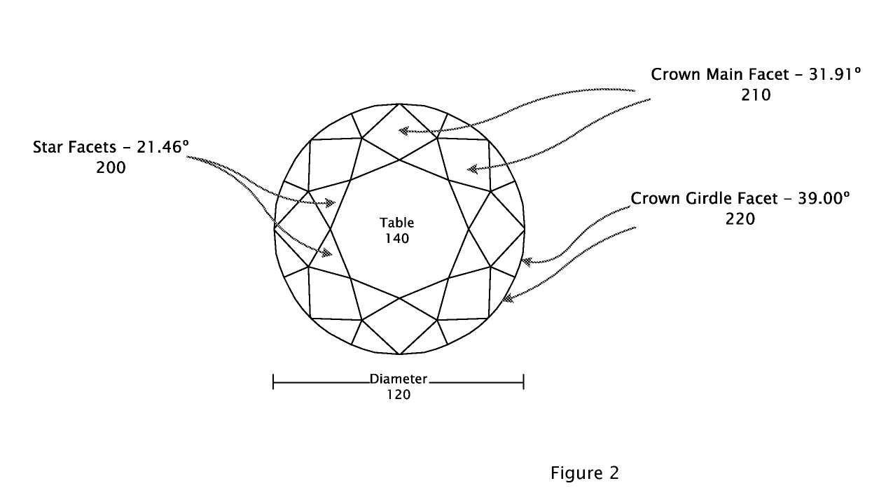

FIG. 2 is a top view of an example of an SiC gemstone cut with a Hearts & Arrows pattern. Star Facets 200, facets surrounding the table, may be cut at 21.46 degrees. Crown Girdle Facets 220, facets on the crown near the girdle, may be cut with an angle of 39.00 degrees. Crown Main Facets may be cut at 31.91 degrees. To reduce clutter in this figure, two of each type of facet is identified. One skilled in the art would recognize that in this figure there are eight Star Facets 200, eight Crown Main Facets 210, and sixteen Crown Girdle Facets 220.

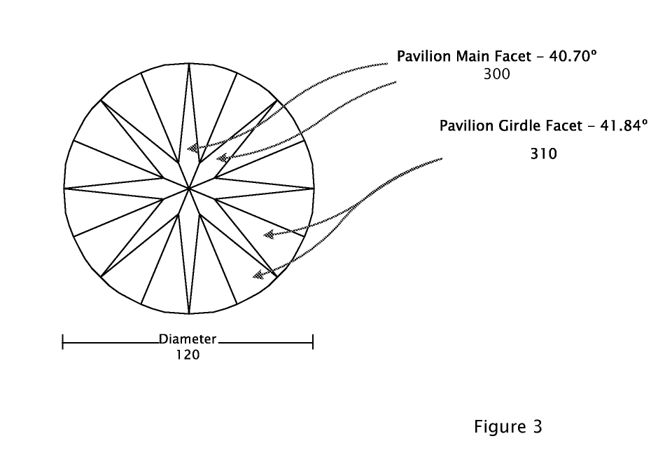

FIG. 3 is a bottom view of an example of an SiC gemstone cut with a Hearts & Arrows pattern. Pavilion Main Facet 300 may be cut at an angle of 40.70 degrees. Pavilion Girdle Facet 310 may be cut at an angle of 41.84 degrees. To reduce clutter in this figure, two of each type of facet is identified. One skilled in the art would recognize that in this figure there are eight Pavilion Main Facets 300 and sixteen Pavilion Girdle Facets 310.

An SiC gemstone cut with the angles indicated may display a Hearts & Arrows pattern. One having skill in the art will recognize that slight variations, up to 0.1 degrees greater or smaller, in the cutting angle may still produce the Hearts & Arrows pattern.

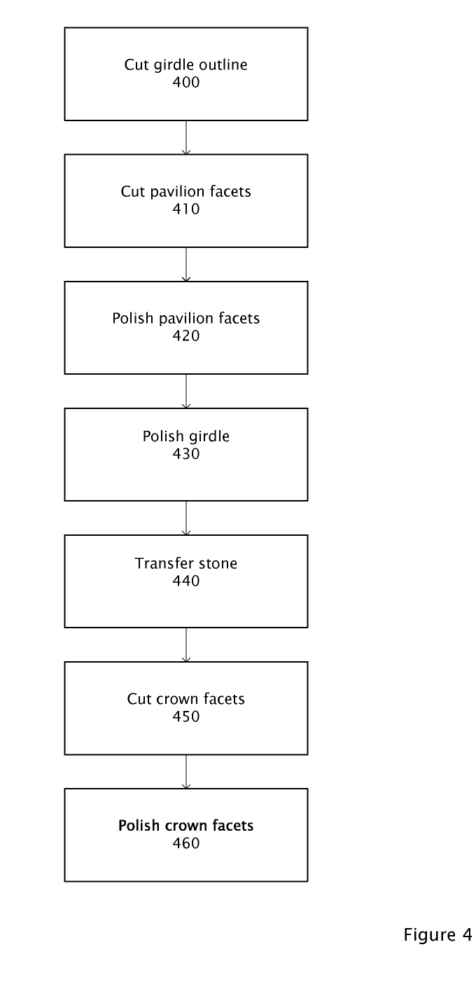

FIG. 4 is an illustration of a flowchart of one way to create an SiC gemstone with a Hearts & Arrows pattern. In this example, a girdle outline is cut 400 to provide a diameter of the SiC gemstone. The pavilion facets are cut 410, including pavilion main facets and pavilion girdle facets.

The pavilion facets are polished 420, as is the girdle 430. The stone is transferred to allow cutting and polishing of the crown side.

The crown main, star, and girdle facets are cut 450, and polished 460.

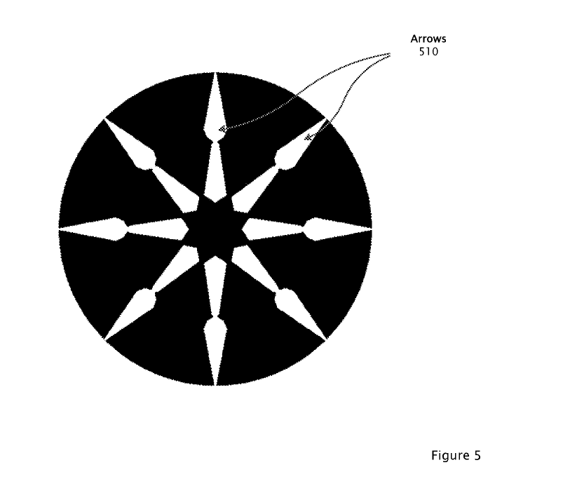

FIG. 5 is an illustration of a bottom view an SiC gemstone with a Hearts & Arrows pattern. The Arrows 510 may be a desired design for an SiC gemstone. To reduce clutter in this figure, only two of the eight Arrows 510 are identified.

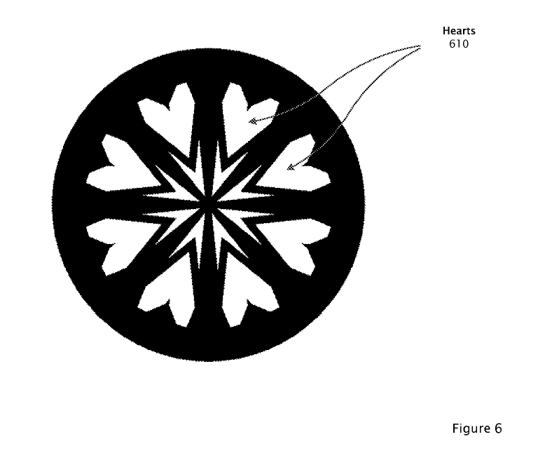

FIG. 6 is an illustration of a top view an SiC gemstone with a Hearts & Arrows pattern. The Hearts 610 may be a desired design for an SiC gemstone. To reduce clutter in this figure, only two of the eight Hearts 610 are identified.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. An SiC gemstone, comprising:
a crown portion comprising:
a plurality of crown main facets cut at an angle of approximately 31.91 degrees;
a plurality of crown girdle facets cut at an angle of approximately 39.00 degrees;
a plurality of star facets cut at an angle of approximately 21.46 degrees;
a pavilion portion comprising:
a plurality of pavilion main facets cut at an angle of approximately 40.70 degrees;
a plurality of pavilion girdle facets cut at an angle of approximately 41.84 degrees; and
a girdle portion abutting the crown portion and extending along a predetermined plane.

2. The SiC gemstone of claim 1 wherein there are 8 crown main facets.

3. The SiC gemstone of claim 1 wherein there are 16 crown girdle facets.

4. The SiC gemstone of claim 1 wherein there are 8 star facets.

5. The SiC gemstone of claim 1 wherein there are 8 pavilion main facets.

6. The SiC gemstone of claim 1 wherein there are 16 pavilion girdle facets.

7. The SiC gemstone of claim 1 wherein the SiC is selected from a group comprising 6H, 4H, and 3C SiC.

8. A method of cutting an SiC gemstone, comprising:
cutting a girdle outline of the SiC gemstone;
cutting a main facet on a pavilion side of the SiC gemstone at an angle of approximately 40.70 degrees;
cutting a girdle facet on the pavilion side of the SiC gemstone at an angle of approximately 41.84 degrees;
cutting a main facet on a crown side of the SiC gemstone at an angle of approximately 31.91 degrees;
cutting a girdle facet on the crown side of the SiC gemstone at an angle of approximately 39.00 degrees;
cutting a star facet on the crown side of the SiC gemstone at an angle of approximately 21.46 degrees; and
cutting a table on the crown side of the SiC gemstone.

9. The method of claim 8 wherein the cutting is performed by a robotic cutting machine.

10. The method of claim 8 further comprising polishing the facets on the crown side of the SiC gemstone.

11. The method of claim 8 further comprising polishing the facets on the pavilion side of the SiC gemstone.
